(19) United States
(12) Patent Application Publication
(10) Pub. No.: US 2013/0170526 A1
(43) Pub. Date: Jul. 4, 2013

(54) Micro FM Audio Transmitter

(71) Applicant: Yung-Yu Lee, New Taipei City (TW)

(72) Inventor: Yung-Yu Lee, New Taipei City (TW)

(21) Appl. No.: 13/342,665

(22) Filed: Jan. 3, 2012

(51) Int. Cl. H04B 1/44

(52) U.S. Cl. 375/219

(57) ABSTRACT

A micro FM audio transmitter comprises a base male terminal receiving power and data transmissions from a digital product and providing audio output, a base female terminal receiving external charge and transferring data to said digital product, and a FM signal conversion transmitter receiving audio output from the base male terminal, transferring it into FM signals and transmitting it. Besides, an audio low-pass control circuit, a dual-frequency selection circuit and a power dependent audio switching circuit are installed, so reducing of volume and preventing electromagnetic interference are achieved.

### FIELD OF THE INVENTION

The present invention relates to a micro FM audio transmitter, particularly to a micro FM audio transmitter applied to digital products.

### BACKGROUND OF THE INVENTION

Digital products have become the major tool of entertainment of everyday life. As to comfort for mobile use, available accessories do not always satisfy users (for example, normal audio output of typical smartphones are not compatible with their wide-ranging entertainment functions). For more entertainment effect appropriate accessories must be installed.

Conventional FM audio transmitters are a widely used technique. In normal used inconunction with digital products, as shown in FIG. 11, a power supply unit 1, providing power for all devices, is usually an built-in battery/dry cell, an audio supply unit 2 from the audio data storage device of the digital product 5, extracts high quality audio output through a 3.5 mm socket; a frequency selection unit 3, using adjustable full-channel technology, needs a frequency regulator and a frequency display; a FM signal transmitter, wherein a high-voltage high-current device is chosen, so more energy and more space are consumed.

As shown in FIG. 11, the conventional FM audio transmitter used for a normal digital product, for more powerful FM audio transmitting effects, more powerfulness of every devices is required. Therefore, the power supply unit has to supply enough power for the requirement of such devices. Especially the configuration and circuits of the conventional FM audio transmitter are very sophisticated. The microshape can cause problems of interference and power shortage.

Accordingly, the micro FM audio transmitter of the present invention can be applied for the newest digital products. Audio of digital products is transmitted through the FM signal, then received by FM radio, transferred into an audio signal and output in more powerful sound. The micro FM audio transmitter of the present invention has several innovative technologies: having a micro appearance and combining perfectly with digital products.

### SUMMARY OF THE INVENTION

The main object of the present invention is to provide a micro FM audio transmitter, wherein internal power is supplied by a digital product, for reducing the volume of the micro FM audio transmitter and preventing electromagnetic interference.

The other object of the present invention is to provide a micro FM audio transmitter providing charge for the digital product without interruption by using FM.

Another object of the present invention is to provide a micro FM audio transmitter extracting audio frequency through a digital product interface, wherein a wireless connection is achieved, and providing clear audio for a FM transmitter.

Another object of the present invention is to provide a micro FM audio transmitter, wherein the audio output interrupts automatically when the digital products are energized, without disturbing normal communication of the digital product, it means, without disturbing by high frequency signals when the digital product is used.

Another object of the present invention is to provide a micro FM audio transmitter, wherein the digital product has full base and more dynamic and eliminates disturbing the high frequency signals of the digital product effectively.

Another object of the present invention is to provide a micro FM audio transmitter, wherein high integrated components are used for reducing volume and transmitting stability of FM signals.

Another object of the present invention is to provide a micro FM audio transmitter, wherein an internal antenna is used, so that in spite of the micro shape a correct FM audio transmitting is achieved.

Another object of the present invention is to provide a micro FM audio transmitter, wherein two fixed frequencies are used, for easily operating selection of full-frequency or DIP frequency of conventional FM audio transmitter. The components are reduced, so miniaturizing of products is achieved.

Other aspects and advantages of the present invention will become apparent from the following detailed description, taken in conjunction with the accompanying drawings, illustrating by way of example the principles of the present invention.

In the first embodiment a micro FM audio transmitter of the present invention comprises a base male terminal receiving power and data transmission from a digital product and providing audio output, a base female terminal receiving external charge and transferring data of the digital product, and a FM signal transmitter receiving the output audio from said base male terminal, transferring it into FM signals and putting out.

In the second embodiment a micro FM audio transmitter of the present invention comprises an audio low-pass control circuit, transferring audio signals passing the male terminal of the digital product into the FM signal conversion transmitter.

In the third embodiment a micro FM audio transmitter of the present invention comprises a dual-frequency selection circuit, so that said micro FM audio transmitter becomes a two-channels-transmitter.

In the fourth embodiment a micro FM audio transmitter of the present invention comprises a power audio switching circuit, wherein audio output interrupts automatically, when digital product is energized.

### BRIEF DESCRIPTION OF THE DRAWINGS

FIG. 1 is a block diagram of the embodiment of the micro FM audio transmitter of the present invention.

FIG. 2 is a circuit diagram of the embodiment of the FIG. 1 of the micro FM audio transmitter of the present invention.

FIG. 3 is a schematic illustration of the power supply circuit of the micro FM audio transmitter of the present invention.

FIG. 4 is a circuit diagram of the technology of charging digital product in the embodiment of the micro FM audio transmitter of the present invention.

FIG. 5 is a circuit diagram of FM audio input in the embodiment of the micro FM audio transmitter of the present invention.

FIG. 6 is a circuit diagram of the power audio switching technology in the embodiment of the micro FM audio transmitter of the present invention.

FIG. 7 is a circuit diagram of audio processing in the embodiment of the micro FM audio transmitter of the present invention.

FIG. 8 is a circuit diagram of frequency selection in the embodiment of the micro FM audio transmitter of the present invention.

FIG. 9 is an exploded view of the micro FM audio transmitter of the present invention.

FIG. 10 is a three-dimensional view of the micro FM audio transmitter of the present invention.

FIG. 11 is a structure diagram of a conventional FM audio transmitter.

### DESCRIPTION OF THE PREFERRED EMBODIMENTS

In the micro FM audio transmitter of the present invention applied to a digital product, stable power and undisturbed audio signals are obtained directly, through a 30-pin dock interlace of such like the series of Apple Iphone, Ipad, Ipod and Samsung GALAXY series. In this way internal space and costs of these two devices in product are avoided. Besides, only two less interfering channels (in Taiwan FM 87.9 HZ and FM 107.9 HZ) are used as switching input/output control (I/O) for selecting the channel, wherein needless interference is prevented. Furthermore an FM frequency high-fidelity transmitter is used for short-range FM transmitting, since for short-range a very powerful transmitter is not necessary.

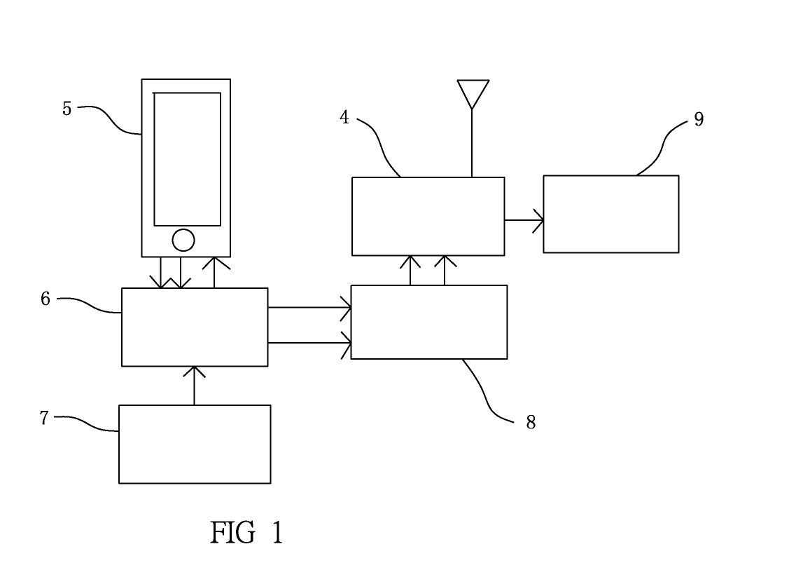

In the micro FM audio transmitter of the present invention, as shown in FIG. 1, the base male terminal (like 30-pin dock) 6 of the digital product 5 receives internal power of the digital product 5 (e.g. 3.3V), receives data transmission of the digital product 5 (like audio signals) for stabilizing power and audio signal output transmitting. The 30-pin dock female terminal 7 charges the digital product 5 with external power, and connects with data of the USB configurated in the digital product 5 to achieve the data transmission. The micro FM audio transmitter of the present invention comprises a 30-pin dock base male terminal 6, a 30-pin dock female terminal 7 and FM signal conversion transmitter 4. Besides, a audio low-pass control circuit 8 passing through the 30-pin dock male terminal 6 special for the digital product 5, receiving audio signals without any medium. Therefore the FM signal conversion transmitter 4 supplies clear audio. A dual-frequency selection circuit 9 makes the micro FM audio transmitter becoming a two-channels-transmitter and get more convenience by operating. Furthermore, power audio switching circuit of the digital product 5, while the digital product is energized, audio output interrupts automatically without disturbing normal communication of the digital product 5.

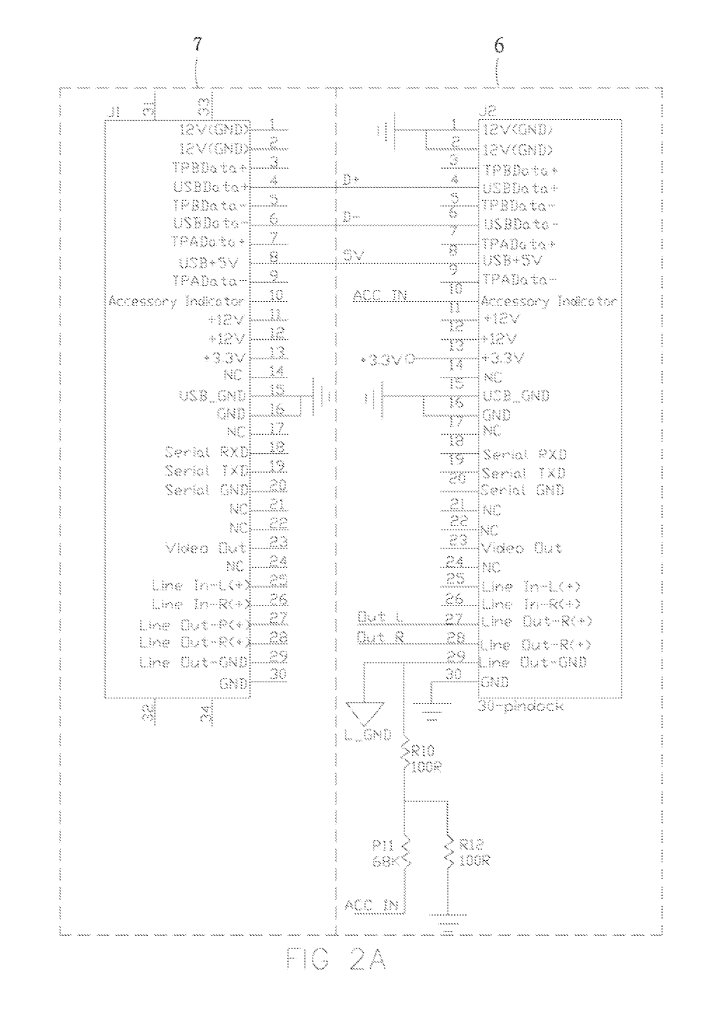

FIG. 2 is a detailed circuit of components of the micro FM audio transmitter of the present invention. The connection of 30-pin dock male terminal 6 and female terminal 7 is manufactured on a circuit board, furthermore, the audio low-pass control circuit 8, FM signal conversion transmitter 4 and the dual-frequency selection circuit 9 are also set on the circuit board.

The innovative technologies of the micro FM audio transmitter of the present invention will be described below:

### I) Power Supply

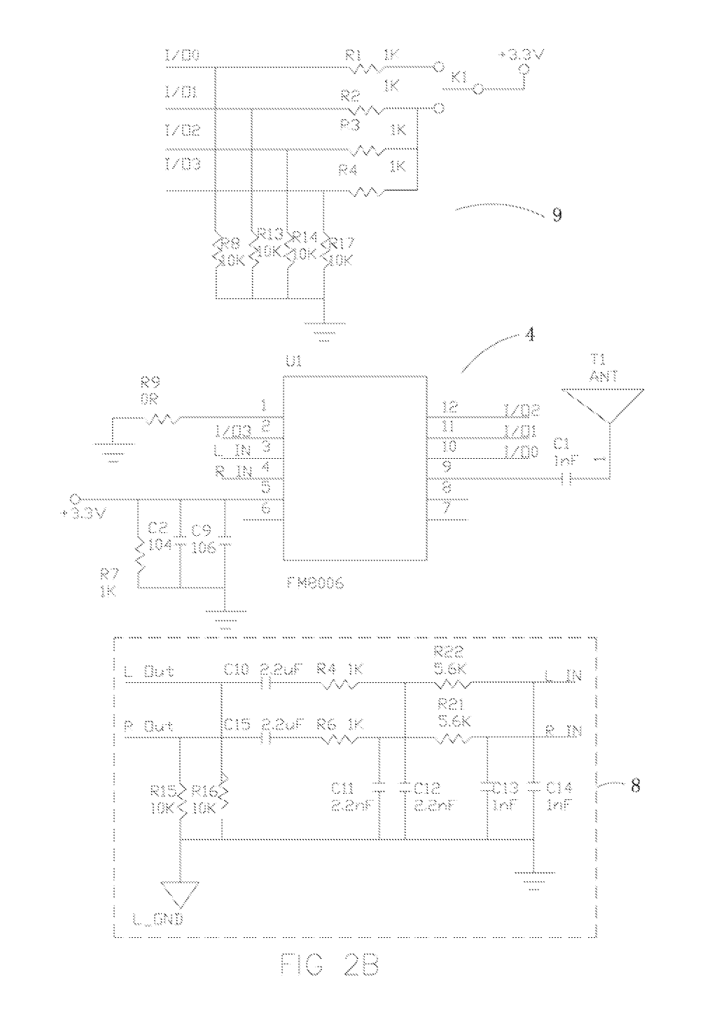

As shown in FIG. 3, in the micro FM audio transmitter of the present invention a internal power is supplied by the digital product (e.g. 30-pin dock base male terminal 6 of iphone interface connection internal power 3.3V), not like in the conventional FM technology power by a dry cell. Since the present invention provides internal power supplying by the digital product, space of FM product is reduced, the FM product is perfectly combined with the digital product. Furthermore, since the product of the present invention and the digital product outputs synchronous power, electromagnetic interference by communication in the conventional FM transmitter is prevented,

### II) Charging Technology of the Charging Jack in the Digital Product:

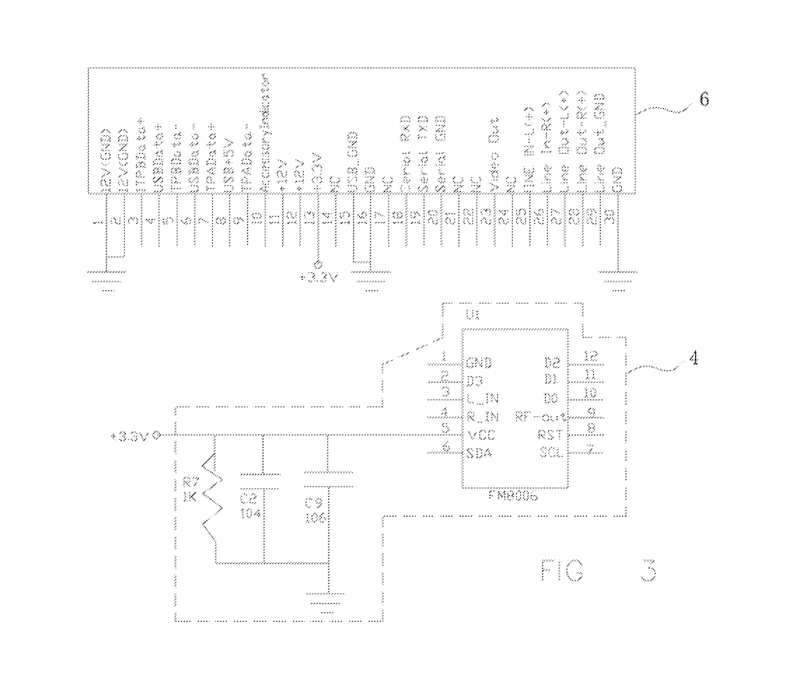

In conventional FM audio transmitter there is no such charging technology of charging jack in digital product. The charging jack in digital product 7 of the micro FM audio transmitter of the present invention is used for charging digital product 5 by external power, then through the 30-pin dock base male terminal 6 supplying said micro FM audio transmitter. The route map is shown in FIG. 4 in combination with FIG. 1. In the present invention, charging within a FM product is achieved, and especially charging is not disturbed while the FM product is in use.

### III) Audio Input

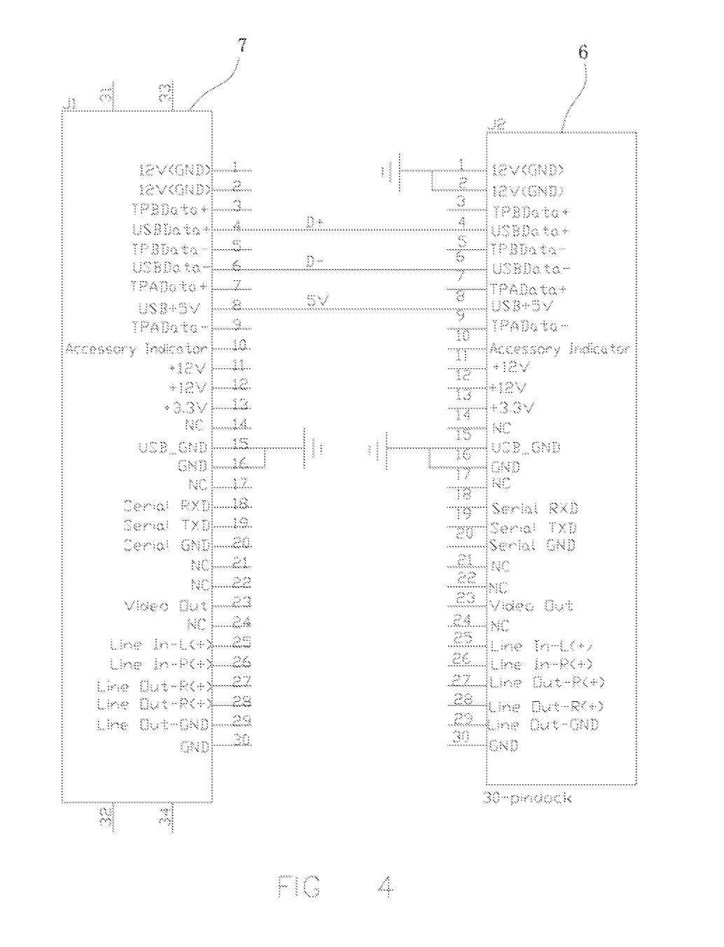

As shown in FIG. 5, in micro FM audio transmitter of the present invention input passes a digital product's interface, e.g. the 30-pin dock base male terminal 6 of iphone, extracting high-quality audio (not like in conventional FM technology, where input passes a 3.5 audio interface), so a wireless connection is achieved, without any media audio signals being extracted directly from digital product and thus the purest audio for the FM transmitter is supplied.

### IV) Power Audio Switching Technology in Digital Product

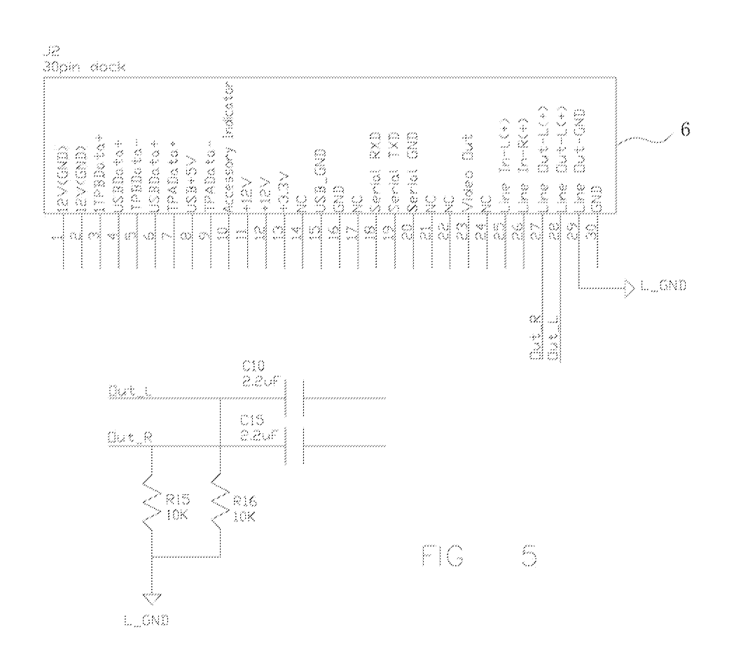

In conventional FM transmitters, there is no such power audio switching technology in digital product. The micro FM audio transmitter of the present invention discloses tire power dependent audio switching technology in digital product. FIG. 6 shows the schema of the micro FM power dependent audio switching. As the digital product 5 is energized, the voltage divider circuit 11 interrupts audio output automatically, without disturbing normal communication by the digital product. By using the digital product (e.g. iphone) in combination with the present product, a interference by high frequency signals is prevented.

### V) Audio Processing

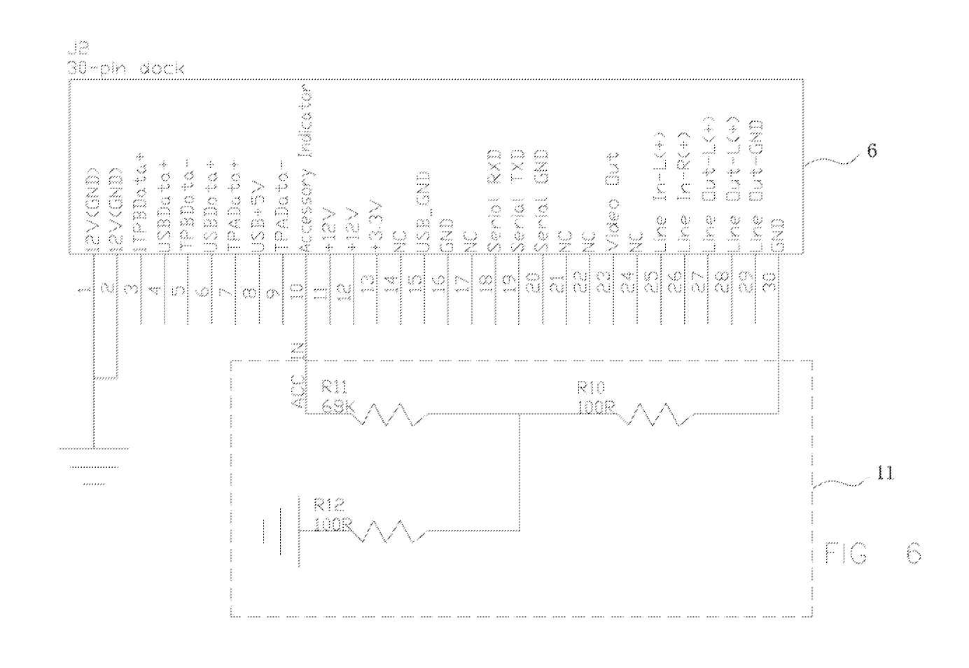

In conventional audio transmitters, there is no such audio processing technology, but signals are sent to the FM transmitter directly. In the micro FM audio transmitter of the present invention, an audio low-pass control circuit in the FM transmitter is disclosed. As shown in FIG. 7, signals pass a internal low-pass control circuit 8, than are sent to the FM transmitter circuit 4. So the digital product has full base and more dynamic and the interference of high frequency of the digital product is prevented.

### VI.) FM Signal Transmitting Technology

In conventional technology master IC and discrete components are used. But in the micro FM audio transmitter of the present invention, highly integrated components are used for the FM transmitter. The FM high integrated circuit prevents unstable transmitting that usually comes about by using discrete components in conventional FM transmitter. Especially high integrated circuit is a requirement for manufacturing micro products.

### Vii.) FM Transmitting Antenna Technology

Conventional FM technology is manufactured with wire/PCB distribution. The micro FM audio transmitter of the present invention is disclosed with an internal antenna for manufacturing FM transmitter, wherein the antenna is correctly positioned in micro product and an efficient transmitting is achieved. So within five meter radius there is no interference by external FM signals.

### VIII.) Frequency Selection Technology

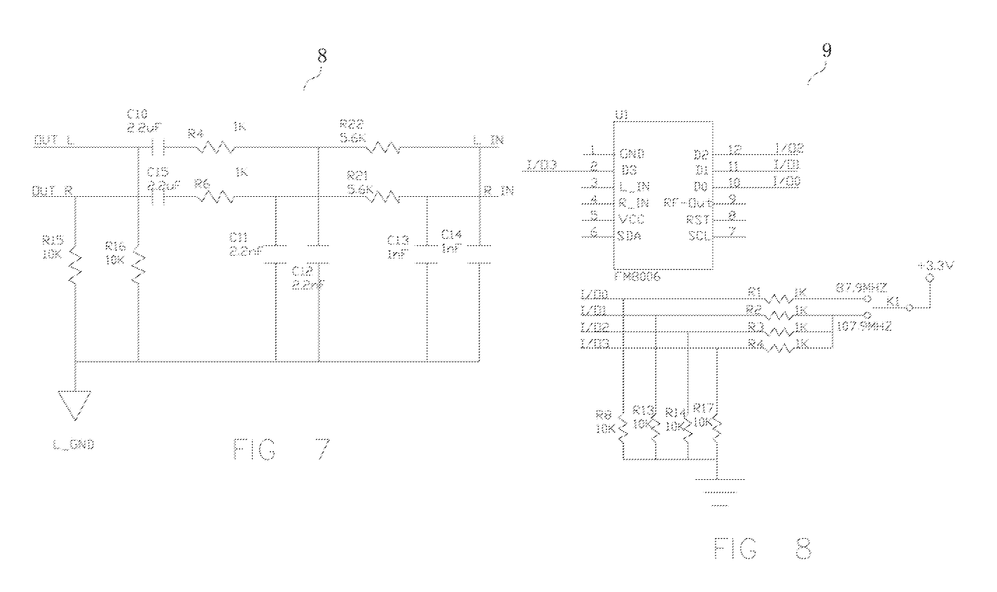

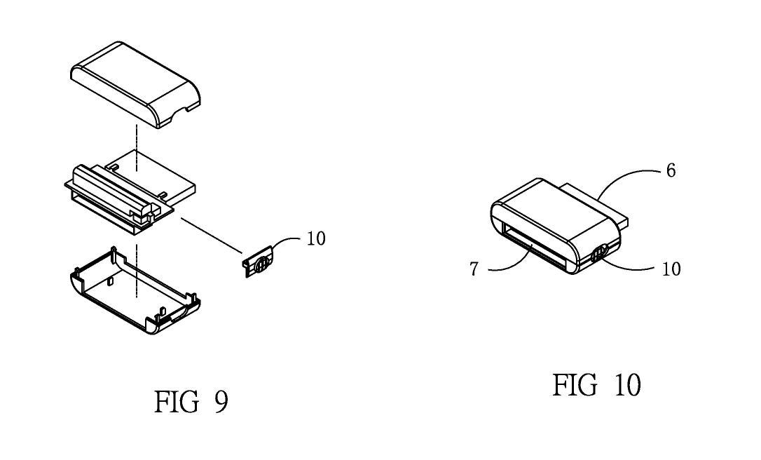

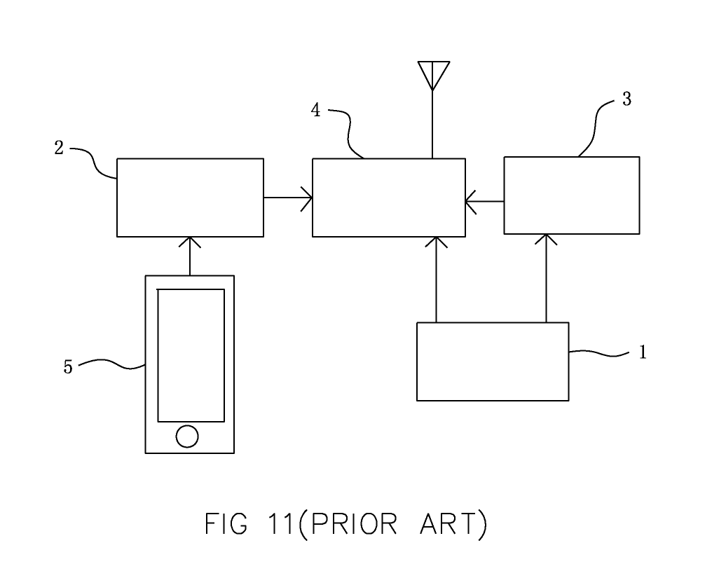

In conventional FM technology, a full-range frequency selection or a frequency selection dial code are used. As shown in FIG. 8, the micro FM audio transmitter of the present invention, there two fixed frequencies, passing toggle switch K1 (via a push button 10, as shown in FIG. 9˜10). The present invention disc loses a two-channels FM transmitter for convenient operating. In the two-channels-selection (e.g. FM 87.9 MHz and FM 107.9 MHz), frequencies of the world FM radio are considered, if the FM radio can not take one of the channels, switching input/output control (I/O) allows to select the other channel. By channel selection, it is not necessary to consider if the channel is identified with the outside channels. Since within five meter of the product there are stronger signals, the stronger signals are preferred by the FM radio. In the present product the full-range frequency selection or the frequency selection dial code of the conventional technology are failed. The components are reduced, that is advantageous for product costs and necessary by miniaturizing.

In the micro FM audio transmitter of the present invention housing and push button of high quality plastic protect the internal components and frequency switching. FIG. 9˜10 shows an exploded view of the micro FM audio transmitter of the present invention, wherein a dual-frequency selection circuit 9 has a push button 10, the micro FM audio transmitter of the present invention is constructed by integrated circuit. FIG. 10 shows a three-dimensional view of the micro FM audio transmitter of the present invention, in which the base male terminal 6, the female terminal 7 and push button 10 are shown.

In the micro FM audio transmitter of the present invention an interface of 30-pin dock base terminal of e.g. series of Apple Iphone, Ipad, Ipod and series of Samsung GALAXY is used for getting stable power directly and audio supply without interference. In this way the space and costs of these two devices are saved. Since there are only two less interfering channels for switching I/O selection, unnecessary interference is prevented. For short-range is a very powerful transmitter not necessary, a FM frequency high-fidelity transmitter is used for short-range FM frequency transmitting. Besides, the internal antenna can be located correctly for micro product. In the micro FM audio transmitter a high-integrated circuit is used for manufacturing the FM transmitter; full-base eliminates the interference of high frequency signals of digital product; passing digital product interface, a wireless connection is achieved, supplying purest audio for the FM transmitter. The micro FM audio transmitter of the present invention has several innovative technologies: the shape is minimized and combined with digital product perfectly, it is applied to, e.g., Apple Iphone series of telephone; Apple Ipod, MP4, Apple Ipad, Samsung GALAXY series of tablet PC, etc.

While preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

1. A micro FM audio transmitter, comprising
a base male terminal, receiving power supply and data transmission from a digital product;
a base female terminal, receiving external charge and data transmission from a digital product; and
a FM signal conversion transmitter, receiving audio output from said base male terminal, and performing transfer thereof into an FM signal and transmission thereof.

2. The micro FM audio transmitter of claim 1, wherein said base male terminal is a pin dock male terminal.

3. The micro FM audio transmitter of claim 1, wherein said base female terminal is a pin dock female terminal.

4. The micro FM audio transmitter of claim 1, further comprising an audio low-pass control circuit, transmitting audio signals which passing said base male terminal in the digital product, to said FM signal conversion transmitter.

5. The micro FM audio transmitter of claim 1, further comprising a dual-frequency selection circuit, wherein said FM signal conversion transmitter becomes a two-channels FM transmitter.

6. The micro FM audio transmitter of claim 5, wherein frequency selection of said dual-frequency selection circuit is achieved by a toggle switch.

7. The micro FM audio transmitter of claim 5, wherein two channels 87.9 MHz and 107.9 MHz are chosen for said dual-frequency selection circuit.

8. The micro FM audio transmitter of claim 1, further comprising a power dependent audio switching circuit, wherein audio input interrupts automatically, when the digital product is energized.

9. The micro FM audio transmitter of claim 1, wherein in said FM signal conversion transmitter an internal antenna is used.

10. The micro FM audio transmitter of claims 1 to 9, wherein an integrated circuit is used for manufacturing said micro FM audio transmitter.
